(19) United States
(12) Patent Application Publication
(10) Pub. No.: US 2005/0151576 A1
(43) Pub. Date: Jul. 14, 2005

(54) ADJUSTABLE IMPEDANCE CIRCUIT

(76) Inventors: Chao-Cheng Lee, Hsin-Chu City (TW); Chia-Jun Chang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/907,032

(22) Filed: Mar. 17, 2005

Related U.S. Application Data
(63) Continuation-in-part of application No. 10/605,327, filed on Sep. 23, 2003.

(51) Int. Cl. H02H 3/20

(52) U.S. Cl. 327/334

(57) ABSTRACT

An impedance apparatus for providing an equivalent impedance between a first node and a second node. The impedance apparatus includes a first impedance device having a first impedance value; a second impedance device having a second impedance value; a first switch element coupled to the first impedance device; a second switch element coupled to the second impedance device; and a controller coupled to the first switch element and the second switch element; wherein the first switch element is controlled by the controller to be periodically turned on and off, and the second switch element is controlled by the controller to be periodically turned on and off.

### CROSS REFERENCE TO RELATED APPLICATIONS

This is a continuation-in-part of U.S. application Ser. No. 10/605,327, which was filed on 23 Sep. 2003 and is included herein by reference.

### BACKGROUND OF INVENTION

1. Field of the Invention

The present invention relates to an impedance circuit, and more specifically, to an adjustable impedance circuit whose equivalent impedance is determined by characteristics of control signal(s).

2. Description of the Prior Art

There are two main problems when manufacturing a passive impedance device for an integrated circuit (IC). The first problem is concerned with the area occupied by large value passive impedance devices in an IC. For example, a resistor in an IC is often implemented by a metal line segment or polysilicon line segment, whose resistance is directly proportional to the length of the line segment. For another example, a capacitor in an IC is often implemented by a structure where a dielectric layer is inserted between two metal layers. The capacitance is directly proportional to the area of the structure. The second problem is concerned with low precision of the passive impedance devices manufactured by semiconductor manufacturing process. Since many factors that cause errors exist in the manufacturing process, it is impossible to manufacture a passive impedance device with its value matching a theoretical value according to the requirements of circuit design. Take a resistor for example, even under the same manufacturing conditions, minute differences between resistances exist. Therefore, the precision of the equivalent impedance value of a resistor is limited due to differences in the manufacturing process. Especially if trying to manufacture two resistors of a similar value (e.g. two resistors with resistances of R and R(1+e⁻⁶) respectively), the conventional semiconductor manufacturing process is not able to fulfill this requirement.

### SUMMARY OF INVENTION

It is therefore one of the many objectives of the present invention to provide an adjustable impedance circuit whose equivalent impedance is determined by characteristics, such as, for example, duty cycle, of at least a control signal.

According to the embodiment of the present invention, an impedance apparatus for providing an equivalent impedance between a first node and a second node is disclosed. The impedance apparatus comprises a first impedance device having a first impedance value; a second impedance device having a second impedance value; a first switch element coupled to the first impedance device; a second switch element coupled to the second impedance device; and a controller coupled to the first switch element and the second switch element; wherein the first switch element is controlled by the controller to be periodically turned on and off, and the second switch element is controlled by the controller to be periodically turned on and off.

According to the embodiments of the present invention, an impedance apparatus operating at an operating frequency, for providing an equivalent impedance between a first node and a second node is also disclosed. The impedance apparatus comprises first impedance device having a first impedance value; a second impedance device having a second impedance value; a first switch element coupled to the first impedance device; a second switch element coupled to the second impedance device; and a control signal generator coupled to the first switch element and the second switch element; wherein the first switch element is controlled by the controller to be continuously turned on and off with an average frequency substantially higher than the operating frequency, and the second switch element is controlled by the controller to be continuously turned on and off with an average frequency substantially higher than the operating frequency.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an adjustable impedance circuit according to the first embodiment of the present invention.

FIG. 2 illustrates an adjustable impedance circuit according to the second embodiment of the present invention.

FIG. 3 is a timing diagram of the first control signal and the second control signal.

FIG. 4 is a flowchart of the operation of the adjustable impedance circuit according to the present invention.

FIG. 5 illustrates an adjustable impedance circuit wherein the impedance devices are inductors according to another embodiment of the present invention.

FIG. 6 illustrates an adjustable impedance circuit wherein the impedance devices are capacitors according to another embodiment of the present invention.

FIG. 7 is a timing diagram of the first control signal and the second control signal according to a non-complementary approach.

### DETAILED DESCRIPTION

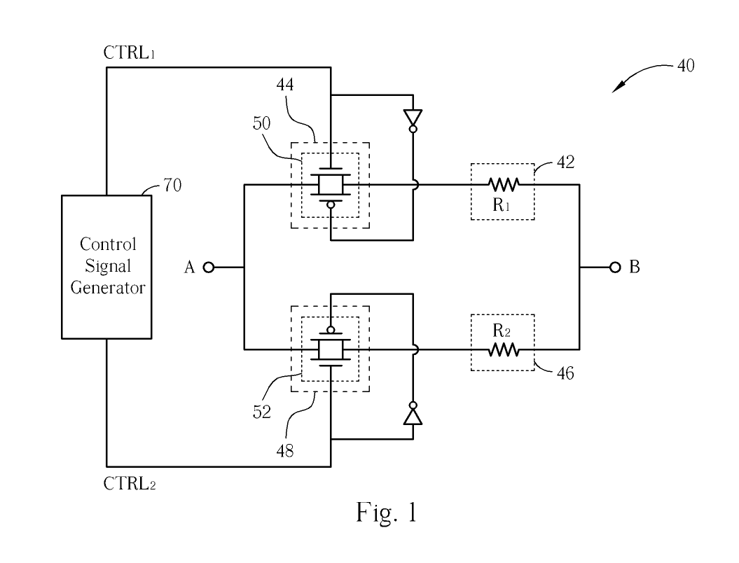

Please refer to FIG. 1 showing an adjustable impedance circuit 40 according to the first embodiment of the present invention. In this embodiment, the adjustable impedance circuit 40 comprises a first impedance 42 formed by a resistor having a resistance of R₁, a second impedance 46 formed by a resistor having a resistance of R₂, a first switch element 44 including a first switch 50 which couples between a first node A and the first impedance 42, a second switch element 48 including a second switch 52 which couples between the first node A and the second impedance 46, and a control signal generator 70 which generates control signals controlling the turning on and off of the first switch element 44 and the second switch element 48. The control signal generator 70 generates a first control signal CTRL₁ and a second control signal CTRL₂, whereby the first switch 50 of the first switch element 44 is controlled to be turned on and off according to the first control signal CTRL₁, while the second switch 52 of the second switch element 48 is controlled to be turned on and off according to the second control signal CTRL₂. In this embodiment, the first switch 50 and the second switch 52 are implemented with known transmission gates typically composed of an NMOS transistor and a PMOS transistor, but are not limited thereto. It is also well known that the function of a switch may be realized by utilizing merely a single NMOS or PMOS transistor.

For the first switch 50 implemented with a transmission gate, the gate of the NMOS transistor is coupled to the first control signal CTRL₁, and the gate of the PMOS transistor is coupled to the first control signal CTRL₁ through an inverter in order to accurately turn on and turn off the transmission gate. While for the second switch 52 also implemented with a transmission gate, the gate of the NMOS transistor is coupled to the second control signal CTRL₂, and the gate of the PMOS transistor is coupled to the second control signal CTRL₂ through an inverter in order to accurately turn on and turn off the transmission gate.

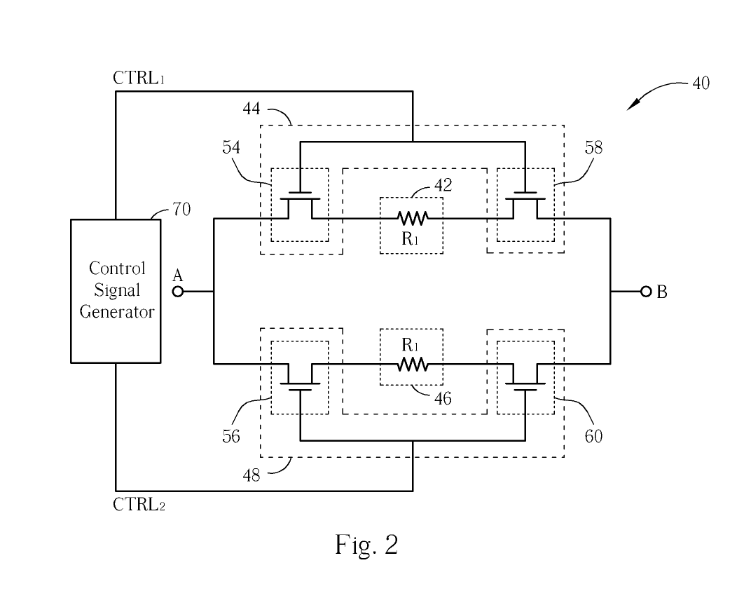

Please refer to FIG. 2 showing the adjustable impedance circuit 40 according to the second embodiment of the present invention. In addition to the similar structure illustrated and depicted pertaining to FIG. 1, in this embodiment, the first switch element 44 further includes a third switch 58 coupled between a second node B and the other end of the first impedance 42, for being turned on and off according to the first control signal CTRL₁. And the second switch element 48 also includes a fourth switch 60 coupled between the second node B and the other end of the second impedance 46, for being turned on and off according to the second control signal CTRL₂.

In this embodiment, both the first switch 54 and the second switch 58 are NMOS transistors, as shown in FIG. 2. The gates of these NMOS transistors are coupled to the first control signal CTRL₁ for being accurately turned on and off according to the first control signal CTRL₁. The third switch 56 and the fourth switch 60 are also MOS transistors, as shown in FIG. 2. The gates of these MOS transistors are coupled to the second control signal CTRL₂ for being accurately turned on and off according to the second control signal CTRL₂.

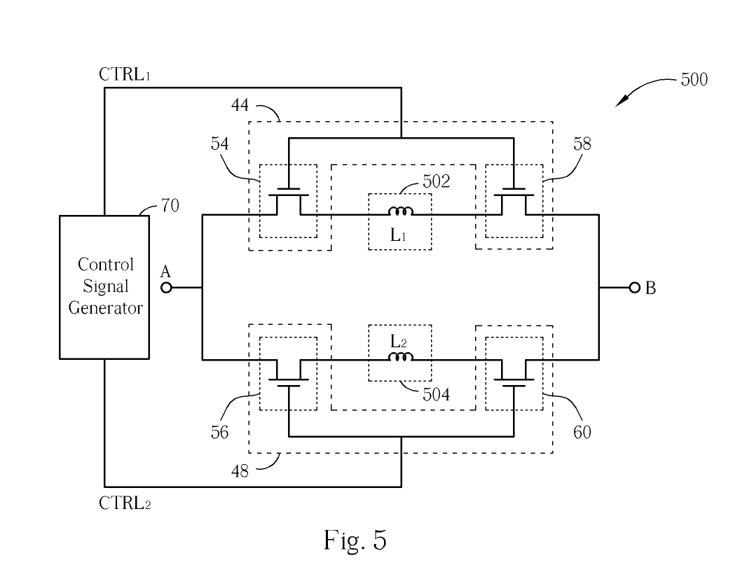

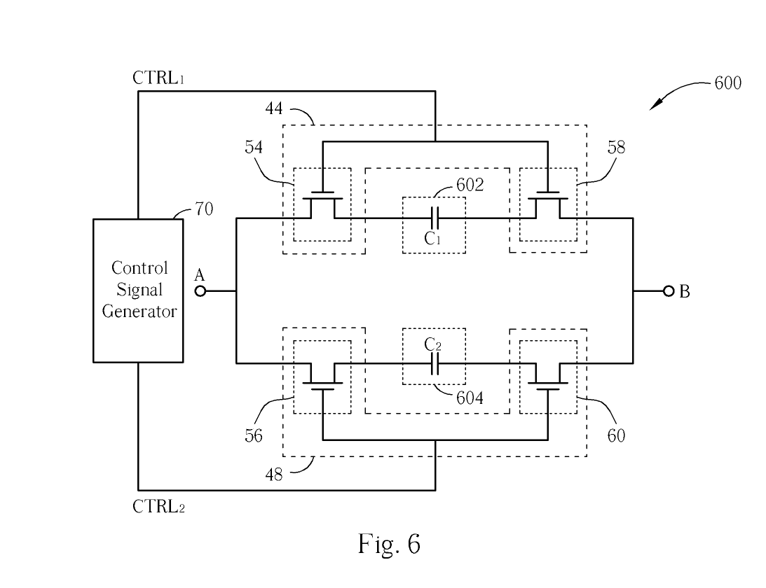

Please notice that although the first impedance 42 and the second impedance 46 are resistors in the embodiments mentioned above, they could also be other impedance devices such as capacitors and inductors. For example, FIG. 5 shows an adjustable impedance circuit 500 wherein the first impedance 502 comprises a first inductor L1, and the second impedance 504 comprises a second inductor L2; and FIG. 6 shows an adjustable impedance circuit 600 wherein the first impedance 602 comprises a first capacitor C1, and the second impedance 604 comprises a second capacitor C2. Additionally, although the first impedance 42 and the second impedance 46 in the embodiments mentioned above are implemented by at least one transmission gate or at least one MOS transistor, other devices which can achieve the same purpose also belong to the present invention.

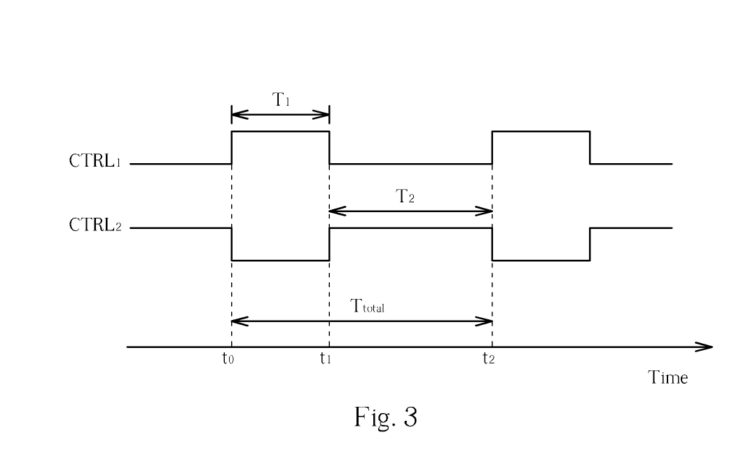

The operation of the adjustable impedance circuit 40 disclosed by the second embodiment of the present invention is further described as follows. Please refer to FIG. 3 showing a timing diagram of the first control signal CTRL₁ and the second control signal CTRL₂ generated by the control signal generator 70 shown in FIG. 1 and FIG. 2. In FIG. 3, the first control signal CTRL₁ is a periodic signal with a period of Ttotal. The first control signal CTRL₁ is at the high level for a duration of T₁, that is, the duty cycle of the first control signal CTRL₁ is DC₁=T₁/Ttotal. The second control signal CTRL₂ is also a periodical signal with a period of Ttotal. The second control signal CTRL₂ is at the high level for a duration of T₂, that is, the duty cycle of the second control signal CTRL₂ is DC₂=T₂/Ttotal. Since the first control signal CTRL₁ and the second control signal CTRL₂ are used to turn on and off a plurality of NMOS transistors, both the first control signal CTRL₁ and the second control signal CTRL₂ are active high signals. In other words, when the first control signal CTRL₁ and the second control signal CTRL₂ are at a high level, the NMOS transistors are turned on. Please notice that although in FIG. 3, the first control signal CTRL₁ and the second control signal CTRL₂ are complementary signals, this is not meant to be limiting. The first control signal CTRL₁ and the second control signal CTRL₂ can be controlled to be both high for a certain period of time and/or be both low for another period of time. Furthermore, the first control signal CTRL₁ and the second control signal CTRL₂ are not limited to periodic signals. Continuously turned-on-and-off but non-periodic patterns may also be applied to the generation of these control signals.

As shown in FIG. 3, between time t₀ and time t₁, since the first control signal CTRL₁ is at a high level and the second control signal CTRL₂ is at a low level, the first switch element 44 in FIG. 2 is turned on so that the first impedance 42 is connected between a first node A and the second node B, and the second switch element 48 is turned off so that the second impedance 46 is disconnected from between the first node A and the second node B. Thus between time t₀ and time t₁, the impedance of the adjustable impedance circuit 40 demonstrates a resistance of R₁. Between time t₁ and time t₂, since the first control signal CTRL₁ is at a low level and the second control signal CTRL₂ is at a high level, the first switch element 44 in FIG. 2 is turned off so that the first impedance 42 is disconnected from between the first node A and the second node B, and the second switch element 48 is turned on so that the second impedance 46 is connected between a first node A and the second node B. Thus between time t₁ and time t₂, the impedance of the adjustable impedance circuit 40 demonstrates a resistance of R₂.

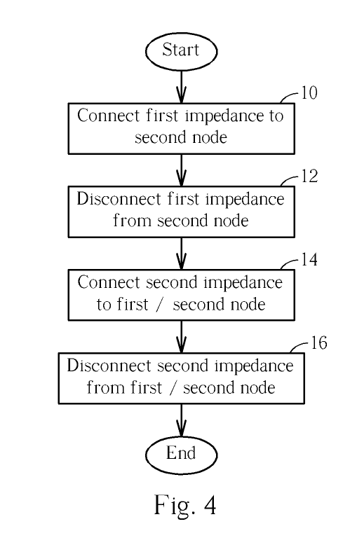

Please refer to FIG. 4 showing a flowchart of the operation of the adjustable impedance circuit according to an embodiment of the present invention. The flowchart comprises the following steps:

Step 10: Connect the first impedance between the first node and the second node;

Step 12: Disconnect the first impedance from between the first node and the second node;

Step 14: Connect the second impedance between the first node and the second node; and

Step 16: Disconnect the second impedance from between the first node and the second node.

As described above, if the time duration between time t₀ and time t₁ is T₁, and the time duration between time t₁ and time t₂ is T₂, when the first control signal CTRL₁ and the second control signal CTRL₂ switch periodically, the equivalent impedance Zeq between the first node A and the second node B can be represented by the following formula:

$$Zeq = \frac{{T}_{1} {R}_{1} + {T}_{2} {R}_{2}}{{T}_{total}} = {DC}_{1} {R}_{1} + {DC}_{2} {R}_{2} \qquad formula 1$$

In this embodiment, since the first control signal CTRL₁ and the second control signal CTRL₂ are complimentary signals, Ttotal=T₁+T₂, and DC₂=1−DC₁. Substitute these equations into formula 1 to obtain formula 2 as follows:
Zeq=DC₁R₁+(1−DC₁)R₂ formula 2

For better performance, the frequencies of the first control signal CTRL₁ and the second control signal CTRL₂ are often higher than the operating frequency of the adjustable impedance circuit 40 (e.g. a factor of ten higher). Please note that the term “operating frequency” of the adjustable impedance circuit herein refers to the frequency of a signal being processed on or transmitted through such adjustable impedance circuit or a circuit block incorporating such adjustable impedance circuit. For example, when the adjustable impedance circuit is used as a building component in a circuit device, for example an amplifier, such as that described in the co-pending application Ser. No. 10/707,803, entitled “Amplifying Circuit”, filed on Jan. 3, 2004 by the same applicant, or a filter, such as that described in the co-pending application Ser. No. 10/709,101, entitled “Low Pass Filter”, filed on Apr. 14, 2004 by the same applicant, which operates to process a signal at a frequency of 1 MHz, the operating frequency of such circuit device, and thus of the adjustable impedance circuit therein, is 1 MHz. As a result, a preferable frequency of the control signals, if periodic, or an average frequency thereof, if non-periodic but continuously turned on and off, may be set to 10 MHz or higher, though not limited thereto. Please further note that by the term “average frequency”, it refers to the number of toggling of a signal within a certain period of time, and thus it can be applied to signals being continuously toggled but with pulses not necessarily uniformly distributed. That is, the term “average frequency” can be applied to non-periodic signals.

If two resistors having similar values are required in an IC, two adjustable impedance circuits 40 can be used (hereinafter referred as adjustable impedance circuit 40a and adjustable impedance circuit 40b). Assume that in the adjustable impedance circuits 40a and 40b, R₁=2R₂, and a very minute difference exists between the duty cycle DC₁ₐ of the first control signal CTRL₁ of the adjustable impedance circuit 40a and the duty cycle DC_{1b} of the first control signal CTRL₁ of the adjustable impedance circuit 40b (e.g. DC₁ₐ=(1+e⁻⁶)DC_{1b}). The ratio of the equivalent impedance Zeqa of the adjustable impedance circuit 40a and the equivalent impedance Zeqb of the adjustable impedance circuit 40b can be obtained by the following formula:

$$\frac{Zeqa}{Zeqb} = \frac{( 1 + {ⅇ}^{- 6} ) D {C}_{1 b} \times 2 {R}_{2} + ( 1 - ( 1 + {ⅇ}^{- 6} ) D {C}_{1 b} ) {R}_{2}}{D {C}_{1 b} \times 2 {R}_{2} + ( 1 - D {C}_{1 b} ) {R}_{2}} = 1 + \frac{{ⅇ}^{- 6}}{1 + \frac{1}{D {C}_{1 b}}} \qquad formula 3$$

According to the result of formula 3, if the duty cycle DC_{1b} of the first control signal CTRL₁ of the adjustable impedance circuit 40b is 0.5, then Reqa=(1+e⁻⁶/3)Reqb.

As described above, the adjustable impedance circuit 40 according to the embodiments of the present invention achieves the purpose of manufacturing two impedances of very close values by the control of the first control signal CTRL₁ and the second control signal CTRL₂. Since the state-of-the-art circuit design techniques may precisely control the characteristics of digital signals (e.g. the duty cycle of the first control signal and the second control signal), the underlying precision impedance requirement can be easily achieved by utilizing the above embodiments of the invention.

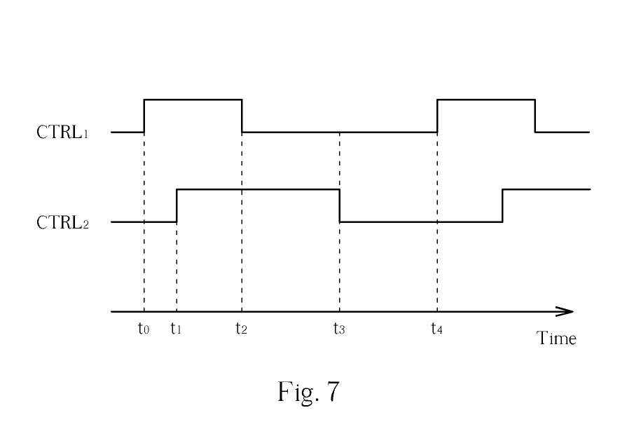

Although the previously depicted embodiment of complementary control signals is preferred, the inventive adjustable impedance circuit may also take a non-complementary approach, as mentioned earlier. Please refer to FIG. 7, which illustrates another timing diagram of the first and second control signal. In FIG. 7, the first control signal CTRL₁ and the second control signal CTRL₂ are generated by the control signal generator 70 to be continuously turned high and low. As can be seen in FIG. 7, and is similar to that in FIG. 3, for the period between time t₀ and t₁, CTRL₁ is high and CTRL₂ is low, whereby the impedance circuit demonstrates an impedance of R₁, while for the period between time t₂ and t₃, is low and is high, whereby the impedance circuit demonstrates an impedance of R₂. However, in FIG. 7 it includes a period between time t₁ and t₂ wherein CTRL₁ and CTRL₂ are both high, and the impedance circuit demonstrates an impedance of R₁ in parallel with R₂, while it also includes another period between time t₃ and t₄ wherein CTRL₁ and CTRL₂ are both low, and the impedance circuit demonstrates an impedance of open circuit. By adjusting the above control signal combination using the control signal generator, a more flexible strategy of generating a desired impedance value can be achieved.

Those skilled in the art will readily observe that numerous modifications and alterations of the device and method may be made while retaining the teachings of the invention. Accordingly, the above disclosure should be construed as limited only by the metes and bounds of the appended claims.

1. An impedance apparatus for providing an equivalent impedance between a first node and a second node, comprising:
a first impedance device having a first impedance value;
a second impedance device having a second impedance value;
a first switch element coupled to the first impedance device;
a second switch element coupled to the second impedance device; and
a controller coupled to the first switch element and the second switch element;
wherein the first switch element is controlled by the controller to be periodically turned on and off, and the second switch element is controlled by the controller to be periodically turned on and off.

2. The impedance apparatus of claim 1, wherein the first impedance device comprises a first resistor, and the second impedance device comprises a second resistor.

3. The impedance apparatus of claim 1, wherein the controller generates a first control signal to control the first switch element, and a second control signal to control the second switch element.

4. The impedance apparatus of claim 3, wherein the duty cycle of the first control signal is adjusted to adjust the equivalent impedance of the impedance apparatus.

5. The impedance apparatus of claim 1, wherein the first switch element is controlled to be periodically turned on and off with a frequency substantially higher than an operating frequency of the impedance apparatus, and the second switch element is controlled to be periodically turned on and off with a frequency substantially higher than the operating frequency.

6. The impedance apparatus of claim 5, wherein the turning-on-and-off frequency of the first switch element is about 10 times higher than the operating frequency, and the turning-on-and-off frequency of the second switch element is about 10 times higher than the operating frequency.

7. The impedance apparatus of claim 1, wherein the first switch element comprises a first switch coupled between the first impedance device and the first node.

8. The impedance apparatus of claim 7, wherein the first switch element further comprises a second switch coupled between the first impedance device and the second node.

9. The impedance apparatus of claim 1, wherein the first impedance device comprises a first capacitor, and the second impedance device comprises a second capacitor.

10. The impedance apparatus of claim 1, wherein the first impedance device comprises a first inductor, and the second impedance device comprises a second inductor.

11. An impedance apparatus operating at an operating frequency, for providing an equivalent impedance between a first node and a second node, comprising:
a first impedance device having a first impedance value;
a second impedance device having a second impedance value;
a first switch element coupled to the first impedance device;
a second switch element coupled to the second impedance device; and
a control signal generator coupled to the first switch element and the second switch element;
wherein the first switch element is controlled by the controller to be continuously turned on and off with an average frequency substantially higher than the operating frequency, and the second switch element is controlled by the controller to be continuously turned on and off with an average frequency substantially higher than the operating frequency.

12. The impedance apparatus of claim 11, wherein the first impedance device comprises a first resistor, and the second impedance device comprises a second resistor.

13. The impedance apparatus of claim 11, wherein the controller generates a first control signal to control the first switch element, and a second control signal to control the second switch element.

14. The impedance apparatus of claim 13, wherein the first control signal and the second control signal are periodic signals.

15. The impedance apparatus of claim 14, wherein the duty cycle of the first control signal is adjusted to adjust the equivalent impedance of the impedance apparatus.

16. The impedance apparatus of claim 11, wherein the average turning-on-and-off frequency of the first switch element is about 10 times higher than the operating frequency, and the average turning-on-and-off frequency of the second switch element is about 10 times higher than the operating frequency.

17. The impedance apparatus of claim 11, wherein the first switch element comprises a first switch coupled between the first impedance device and the first node.

18. The impedance apparatus of claim 17, wherein the first switch element further comprises a second switch coupled between the first impedance device and the second node.

19. The impedance apparatus of claim 11, wherein the first impedance device comprises a first capacitor, and the second impedance device comprises a second capacitor.

20. The impedance apparatus of claim 11, wherein the first impedance device comprises a first inductor, and the second impedance device comprises a second inductor.
